(19) United States
(12) Patent Application Publication
(10) Pub. No.: US 2004/0059036 A1
(43) Pub. Date: Mar. 25, 2004

(54) Method and composition for waterproofing

(76) Inventor: John H. Gaveske, Blaine, MN (US)

Correspondence Address: MERCHANT & GOULD PC, P.O. BOX 2903, MINNEAPOLIS, MN, 55402-0903, US

(21) Appl. No.: 10/253,548

(22) Filed: Sep. 23, 2002

(51) Int. Cl. C08J 3/00

(52) U.S. Cl. 524/445; 524/493

(57) ABSTRACT

A method and coating for waterproofing and sealing a structural unit which include applying a coating composition to a surface of a structural unit. The coating composition includes a solvent, binder resin, and a filler.

### FIELD OF THE INVENTION

This invention relates generally to the field of waterproofing and sealing structures. In particular, the invention relates to a method of waterproofing and sealing a structural unit using a composition that includes a styrene polymer based binder resin, an organic solvent, and a filler.

### BACKGROUND OF THE INVENTION

Structures used in construction, such as foundations and walls, include materials, such as masonry, cement, wood, plaster, stone, clay or brick that may be porous. Such porous materials are susceptible to cracking and can be degraded by water and/or loss of water from the porous materials. Below grade structures are often subjected to hydrostatic pressure from ground water. Above grade structures are subject to precipitation, moisture migration, and water from other sources. A variety of methods and products for waterproofing and/or sealing these structures against outside water have been developed.

Moisture that penetrates into a structure can cause a number of problems. For example, moisture can cause mold growth, which can result in illness and even death to the occupants of the structure. These “sick” structures are becoming more common.

One type of existing waterproofing and/or sealing system includes polyvinyl or polyethylene sheeting adhered or fastened to the surface of the structure. If an adhesive is used to adhere the sheeting to the structure, the adhesive may not stick well due to dust (e.g., cement or stone dust) produced during construction and other activities and lose its adhesion over time. On the other hand, if fasteners, such as nails or staples, are used to attach the sheeting to the structure, the fasteners typically puncture the sheeting and the structure beneath, providing a channel through which water can flow. Moreover, there are seams between the sheets that require the use of a fastener or adhesive to close. The adhesive may be attacked by microorganisms and/or oxidation and degraded or may dissolve in water over time, allowing water to flow through the seam. Fasteners puncture the sheeting and allow water through the resulting holes. In addition, the waterproofing sheets are often difficult to form around non-uniform structures and adverse weather conditions may hinder the placement of the sheets on the structure. For example, wind may cause wrinkles in the sheet as it is positioned on the structure and, on very cold days, the sheets may tear or even shatter during installation.

Another type of existing waterproofing and/or sealing system includes the application of a coating composition on the structure. One common type of coating composition for waterproofing and sealing is tar- or asphalt-based. Although these compositions are relatively inexpensive and can be applied year-round, the materials in the composition often leach away from the wall. This often contaminates the soil and reduces the amount of protection afforded by the coating. Moreover, these compositions typically contain a large amount of organic material, which may be attacked by soil- or water-borne microorganisms, thereby reducing the effectiveness of the coating.

Other types of coating compositions have been developed, such as those described in U.S. Pat. No. 5,576,062. Many of these coating compositions fail to provide a continuous coating over a surface being treated due to the low viscosity of the coating composition. These lower viscosity coatings may not completely fill, only bridge, or shrink away from the numerous holes in cement, masonry blocks, or other porous substrates leaving the surface looking uneven and more susceptible to damage and cracking.

Many coating compositions do not produce a durable film over porous substrates (e.g., cement, masonry blocks, wood, etc.). Often, the film that is formed using these coating compositions is easily punctured, pulled away from the substrate, and/or includes components that are degradable or leach away from the film thus losing its adhesion to substrates. Some of these coating compositions need to be applied with a significant amount of volatile organic compounds as solvents. These emitted volatile organic compounds (VOCs) are limited by current environmental regulations, and, often the VOCs range from about 500 to 600. As environmental regulations continue to become more stringent, lower VOC values are needed. Additionally, coatings that include significant amounts of solvent typically make the composition more costly. Moreover, a number of the coating compositions are difficult to apply.

Beyond the problems discussed above, the state of the art coating compositions are generally fragile, and they must be protected during backfilling of earth around the masonry structures. Without such protection, the sheets or coatings can be ruptured, torn, pulled down along vertical surfaces by the backfill, etc. Additionally, many of these coating systems require that the masonry structure be dry or contain only a trace of dampness which requires careful protection of the structure before application of the waterproofing/sealing system. These systems may require several hours if not days of drying time prior to backfill. Further, many of the coating systems fail to effectively bind the components of mixtures together and coat the surface being treated.

There is a need for alternative waterproofing and/or sealing compositions which emit less volatile organic compounds upon application, are durable, bond well to substrates, possess a long life span, are stable in below grade and above grade applications, prevent the formation of mold, cure in a short amount of time, cost less, and provide a continuous coat over a surface. In addition, an improved method of waterproofing and sealing structures is needed which is useful year round, which can be applied more conveniently to all types of masonry and concrete surfaces.

### SUMMARY OF THE INVENTION

The present invention relates to methods and compositions for waterproofing and sealing a surface of a substrate. The coating compositions typically include a styrene based polymer binder resin, a solvent, and a filler. Several unexpected advantages result over prior systems result from the addition of finely ground sand fillers to coating compositions. The addition of finely ground sand fillers to the compositions results in lower VOCs, reduction in the amount of solvent, more effective binding of the components of the mixture, easier application of the coating composition to the surface of the substrate, better coating composition coverage of the surface, prevention of the formation of mold, reduce cure times, provide a continuous coat over a surface, and lower cost. Accordingly one aspect of the present invention is a waterproofing, chemically resistant coating composition useful for structural units that includes: about 125 to 235 parts by weight of an organic solvent; about 100 parts by weight of a binder resin, the binder resin comprising a styrene based polymer having a styrene content of 60 wt % or greater, the styrene based polymer selected from the group consisting of a styrene homopolymer, a styrene copolymer, and mixtures thereof; and about 290 to 1900 parts by weight of a filler, the filler having a size that allows at least 60 percent of the filler to pass through a 325 mesh screen.

Another aspect of the present invention includes a method of waterproofing and sealing a structural unit employing the steps of: applying a coating composition to the surface of the substrate, the coating composition comprising about 125 to 235 parts by weight of an organic solvent; about 100 parts by weight of a binder resin, the binder resin comprising a styrene based polymer having a styrene content of 60 wt % or greater, the styrene based polymer selected from the group consisting of a styrene homopolymer, a styrene copolymer, and mixtures thereof; and about 290 to 1900 parts by weight of a filler, the filler comprising sand.

Yet another aspect of the present invention is a method for preparation of a composition, the method comprising the steps of: mixing an organic solvent with a portion of a filler, wherein the portion of the filler is about 12 to 25 percent of a total weight of the filler; mixing a binder resin into the organic solvent and portion of the filler; adding a remainder of the filler; and mixing the remainder of the filler.

The above summary of the present invention is not intended to describe each disclosed embodiment or every implementation of the present invention. The detailed description which follows more particularly exemplify these embodiments, but do not limit the scope of the invention, as defined by the claims.

### DETAILED DESCRIPTION OF THE PREFERRED EMBODIMENTS

The present invention is believed to be applicable to methods and coating compositions for waterproofing and/or sealing a surface of a substrate. In particular, the present invention is directed to methods and coating compositions using a combination of a binder resin, a solvent, and a filler.

While the present invention may not be so limited, an appreciation of various aspects of the invention will be gained through a discussion of the examples provided below.

The term “polymer” includes homopolymers and copolymers, unless otherwise indicated.

The term “monomer unit” indicates a unit of a polymer which is derived from or has the same chemical structure as a unit derived from a particular monomer.

The term “substrate” includes any surface that is capable of being coated with the composition of the invention.

A preferred substrate is a “structural unit.” The term “structural unit” includes, by way of example, foundations, basement walls, retaining walls, cement posts, other building walls, dry wall, pool enclosures, tub and shower enclosures, highway structures (e.g., posts and walls), wooden or metal fence posts, sheet rock, plywood, wafer board, wall sheeting, pressed board, containment basins and walls, fabricated walls, floor panels, roofs, plaza decks, decks, floors, concrete, pre-stressed concrete other substrates that are buried or are exposed to water or weathering conditions, and the like. These structural units are typically made from masonry, cement, wood, plaster, stone, gypsum, clay, brick, tile, terra cotta, cardboard, paper, and the like.

Unless otherwise indicated, all units of measurement that indicate the number of parts by weight of a particular component in a coating composition are based on a coating composition having 100 parts by weight of binder resin.

Structural Units

The present invention is useful in methods for protecting above ground or subterranean masonry and concrete structures that are susceptible to chemical attack, e.g. sewage systems, and systems used in the pulp and paper industry. These masonry or concrete structures may be tanks, pipes walls, retaining walls, cement posts, and the like. The structures may include poured concrete, block and mortar, and the like. The masonry structures may ultimately be completely buried, or may be partially exposed to the atmosphere. The masonry structures may or may not comprise reinforcing bars, rod, mesh, and the like. Basically, the invention is useful to waterproof structures which are less flexible than the coating itself. In other words, if the waterproof coating which results from the application of the liquid coating composition is slightly more flexible and elastic than the surface to be coated, the movement of that surface after application of the coating will not cause cracks in the coating. Therefore, the coating will remain an effective water barrier.

The structures may also have defects that require filling prior to coating. Such defects can be cracks and fissures, and they can be a result of concrete form ties, cold joints in concrete, and the like.

Binder Resins

The binder resin may be a styrene based polymer including a styrene homopolymer (polystyrene), a copolymer including styrene, a mixture of polystyrene and one or more polymers, or a combination of the above. Preferably, the styrene based resin includes a styrene content of greater than about 60 wt-%. More preferably, the styrene based resin includes a styrene content of greater than about 80 wt-%.

The styrene copolymer may comprise a styrene and a rubbery diene co-monomer including isoprene, butadiene, and the like, or it may comprise co-monomers such as acrylonitrile, acrylates, olefins such as butylene, and the like. These copolymers may be random or block copolymers. The styrene polymeric resin can be a general purpose grade, crystalline, high impact, or medium impact grade of polystyrene. Increasing amounts of styrene copolymers such as styrene-butadiene and styrene-isoprene tend to increase the difficulty in completely dissolving the binder resin, but it is possible to use high impact polystyrene and medium impact polystyrene resins in the present invention. Preferably, the styrene resin comprises a general purpose grade or high impact grade of polystyrene.

The resin binder may be virgin resin, regrind resin, recycled resins, or a mixture thereof. Preferably, the resin binder is a recycled styrene homopolymer.

The polymer used for the binder resin may include a combination of up to three types of polymers. These three types include a) styrene-diene copolymers having a styrene content of 60 wt. % or greater and typically from about 85 to 99 wt. % and, preferably, from about 90 to 99 wt. %, b) a copolymer having styrene and olefin monomer units with a styrene content of 60 wt. % or greater, and c) polymers having styrene monomer units with a styrene content of 60 wt. % or greater and typically from about 85 to 99 wt. % and preferably, from about 90 to 99 wt. %. The combination of polymers are typically chosen to produce a durable film with elastomeric properties.

Typical diene monomer units include butadiene and isoprene. Butadiene is the preferred diene monomer unit. Typical olefin monomer units include ethylene, propylene, butylene (i.e., 1-butene and isomers), and isobutylene (i.e., isobutene). Preferred olefin monomer units include ethylene, butylene, and isobutylene.

A binder resin that includes a polymer having a relatively high styrene-content (styrene content greater than 60 wt. %) may increase the hardness and durability of a film formed from the coating composition. This high styrene-content polymer may be a styrene homopolymer or a copolymer of styrene with, for example, one or more diene, olefin, acrylonitrile, and/or acrylate monomer units. Suitable high styrene-content polymers include, for example, polystyrene homopolymer, high impact polystyrene (HIPS), and medium impact polystyrene (MIPS). Both HIPS and MIPS are often copolymers of styrene and a diene, such as butadiene. HIPS and MIPS typically have a styrene content that ranges from 60 wt. % to 99 wt. %. Typically HIPS has a styrene content of least about 85 wt. % and preferably at least about 90 wt. %. Typically MIPS has a styrene content of least about 85 wt. % and preferably at least about 95 wt. %. Commercially available HIPS copolymer include, for example, HIPS Huntsman-HiVal 5308L from Ashland Specialty Chemical (Columbus, Ohio).

The impact resistance of films formed using coating compositions having high styrene-content polymers typically increases as the overall diene content increases. The diene content of the coating composition may be modified, for example, by using a polymer with higher diene-content or decreasing the amount of the high styrene-content polymer in the polymeric binder resin. The impact resistance of the film may also be modified by the addition of a plasticizer. On the other hand, the hardness of films formed using these polymers typically decreases as the diene content increases. Thus, the desired properties of the film may be tailored by varying the polymeric binder resin composition.

Polymers with a styrene content of less than 60 wt % may be optionally added to the polymeric binder resin. These polymers include styrene-diene copolymers and styrene-olefin copolymers. One example of a suitable styrene-diene copolymer is a styrene-diene-styrene triblock copolymer which has two endblocks of polymerized styrene monomer units separated by a central block of polymerized diene monomer units. Suitable triblock polymers include, for example, styrene-butadiene-styrene (S-B-S) polymers and styrene-isoprene-styrene (S-I-S) polymers. Commercial S-B-S and S-I-S polymers include, for example, many of the Kraton® D 1100 Series polymers from Shell Chemical Company (Houston, Tex.) and Stereon® Block Copolymers from Firestone Synthetic Rubber & Latex Co. (Akron, Ohio). For example, Kraton® D 1101 and D 1102 are S-B-S polymers and Kraton® D 1107 is an S-I-S polymer. These copolymers typically have a styrene-content of about 5 to 60 wt % and usually about 10 to 35 wt %.

Another example of a suitable styrene-diene copolymer is a styrene-diene diblock polymer, such as a styrene-butadiene (S-B) copolymer or a styrene-isoprene (S-I) copolymer. Commercially available triblock polymers often include at least some diblock polymer.

The styrene-diene copolymer portion of the polymeric binder resin may include at least one block copolymer. Random copolymers may also be used, particularly in combination with a block copolymer or copolymers.

The polymeric binder resin may include at least one styrene-olefin copolymer with a typical styrene-content less than 60 wt. % and preferably ranging from about 10 to 60 wt. %, and more preferably, about 20 to 50 wt. %. Such copolymers combine the hardness of the styrene monomer units with the elastomeric properties of the olefin monomer units. The styrene-olefin copolymer portion of the polymeric binder resin typically includes at least one block copolymer, however, random copolymers may also be used, particularly in combination with block copolymers. Examples of styrene-olefin copolymers include styrene-ethylene-butylene-styrene (S-EB-S) block copolymers, styrene-ethylene-propylene-styrene (S-EP-S) block copolymers, styrene-ethylene-butylene (S-EB) block copolymers, and styrene-ethylene-propylene (S-EP) block copolymers. Examples of these copolymers include Kraton® G 1600 and 1700 series polymers and Kraton® FG 1900 series polymers. A preferred polymer of this type is the styrene-ethylene-butylene-styrene polymer, such as, for example, many of the Kraton® G 1600 Series polymers, including Kraton® G 1650 and 1652 polymers.

The polymeric binder resin may additionally include at least one polyolefin. Suitable examples of polyolefins include polyethylene, polypropylene, and polybutene. Preferred polyolefin include polyethylene, polybutene, polyisobutylene, and polymers having a combination of butylene and isobutylene monomer units (e.g., a polymer having about 25 to 30 wt. % isobutylene monomer units and about 70 to 75 wt. % butylene monomer units). Polyolefins may be obtained from a variety of manufacturers and distributors.

The above polystyrene polymers can be mixed with rubbery polymers to form the binder resin. Such rubbery polymers include, for example, unvulcanized natural rubber, chlorinated natural rubber, chlorinated sulfonated polyethylene rubber, styrene-butadiene rubber, polybutene rubber, chlorinated paraffin, and mixtures thereof.

The styrene polymeric resins used in the present invention may be modified by plasticizers, coupling agents, and the like. Such modified resins include high impact polystyrene such as styrene-butadiene modified high impact and medium impact polystyrene.

Solvents

The polymers and resins that form the polymeric binder resin are dissolved and/or dispersed in an organic solvent to form a coating composition. The amount of solvent used determines the drying time, and appropriate method of application for the coating composition. A variety of solvents may be used. Suitable solvents that are commonly used include, for example, aromatic hydrocarbons, cycloaliphatic hydrocarbons, terpenes, unsaturated hydrocarbons, organic carbonates, and halogenated aliphatic and aromatic hydrocarbons. Suitable solvents include toluene, xylene, benzene, halogenated benzene derivatives, ethyl benzene, naphtha, cyclohexane, methylene chloride, ethylene chloride, trichlorethane, chlorobenzene, propylene, ethylene carbonate, nitropropane, acetone, ethyl acetate, propyl acetate, butyl acetate, and isobutyl isobutyrate. Preferred solvents are aromatic hydrocarbons, such as toluene, xylene, benzene, and halogenated benzene derivatives. Mineral spirits can be used as a diluent in combination with a solvent.

For environmental reasons, it is desirable to use as little solvent as possible in the coating composition. The lower limit on the amount of solvent may be determined by the amount of solvent needed to solvate and/or disperse the components of the coating composition. If too little solvent is used, then the coating composition may be too viscous for the particular application. On the other hand, if too much solvent is used, the coating composition may not have the necessary viscosity to ensure that a proper coating is deposited on the structural unit and an excessive amount of VOCs are emitted into the environment. This can result in a film that may be thin, easily punctured, and/or have an unacceptable amount of pinholing. In addition to the use of a solvent, the viscosity of a coating composition may often be reduced by warming the coating composition.

Fillers

The coating composition typically includes a filler. The filler may increase the strength of the coating composition and/or replace costly materials of the polymeric binder resin. The filler may also modify the physical properties of the coating composition and films formed using the coating composition, including, for example, the color, opacity, affinity for other coatings, density, rheology, stiffness, and modulus of the coating composition and/or film. Any particular filler may have one or more of these, or other, functions in the coating composition.

In addition, a coating composition with a filler may more easily and reliably cover holes, depressions, recesses, cracks, and crevices in a substrate, for example, in masonry blocks, concrete, wood, and other porous or rough substrates. The presence of a filler may reduce the size and number of pinholes in a film formed from the coating composition. These pinholes arise, at least in some cases, because of gravity and/or capillary action that draws the coating composition into the hole, depression, recess, crack, or crevice in the substrate, creating a break or pinhole in the resulting film. The filler often includes particles that, because of their larger size, provide structural support that, in combination with the polymeric binder resin, forms a film across or fills the hole, depression, recess, crack, or crevice. This reduces the tendency to form pinholes.

Suitable fillers include, for example, carbonates, clays, talcs, silicas including fumed silica and amorphous silica, silico-aluminates, aluminum hydrate, metal oxides (e.g., oxides of aluminum, iron, zinc, magnesium, and titanium), silicates (e.g., mica), sand, Portland cement, carbon filaments, glass, fiberglass, cellulose, graphite, mortar powder, calcium carbonate, sulfates (such as magnesium or calcium sulfates), and the like. Preferred fillers include sand, titanium dioxide, oxides, and clay.

More preferable fillers include ground sand materials. For example, preferred sands are those of a particle size that allows at least 60 percent of the material to pass through a 325 mesh screen. Preferred sands have a Blaine air permeability, according to ASTM International C204-00 (“Standard Test Method for Fineness of Hydraulic Cement by Air Permeability Analysis”), expressed as total surface area of from about 2100 to 3200 square centimeters per gram of material.

Some ground sand materials may include crystalline silica such as quartz and Cristobalite. Commercial sand products include, for example, silica flour that can be obtained from Abrasive Technologies, Inc. (Woodbury, Minn.). Other commercial finely ground products include talcs, silicas, silicates, crystalline mica, and fumed silica. In other embodiments, a filler can include a mixture of particle sizes and different sand materials.

The amount of filler in the coating composition typically depends on the desired properties of the composition. These properties may include the strength, flexibility, ultraviolet radiation resistance, chemical resistance, permeability, and cost of the coating composition. Often more than one type of filler is used. A combination of fillers may provide desired advantages for the coating composition and/or overcome disadvantages arising from other components in the film. For example, a filler can include a mixture of sand and clay.

The filler component of the composition is useful to increase the strength of the resulting film layer. The filler also decreases the amount of the more expensive binder resin needed in the composition, increases the bulk and weight of the resulting film, and otherwise modifies the physical properties of the film and film forming composition. The major modifications which can be achieved with fillers are changes of color or opacity, changes of density, increase of solids content, change of rheology, increase in stiffness or modulus of the coating, and changes in the affinity of the coating for various adhesives, cements, mortars, and the like.

Optional Components

The coating composition may optionally include a pigment or dye. The pigment or dye may impart a desired color to the coating composition and may be added for aesthetic purposes. The pigment or dye may also be included in the coating composition to, for example, aid the user in determining which portion of a surface has been covered by the coating composition. The pigment or dye may also absorb light, which can harm the film. For example, the pigment or dye may absorb one or more wavelengths of ultraviolet (UV) light.

Pigments and dyes may be powders, flakes, metal flakes, organic or organometallic molecules, and the like. Examples of suitable pigments and dyes include iron lakes, iron oxide, such a red, yellow, and black iron oxides, other metal oxides, and carbon black. These solids not only impart color to the composition to allow the user to determine coverage of the structure and to render the film coating relatively impervious to UV light, but also provide chemical resistance to the film coating. In addition to compounds used primarily as pigments or dyes, the coating composition may also include other components, such as the filler material, that also act as a pigment or dye. For example, titanium dioxide which may also be a filler, is a pigment. In such cases, the amount of the filler/pigment (e.g., titanium dioxide) in the coating composition may be representative of that described above for the filler material.

Another optional additive is an antioxidant. Polymers with styrene and diene monomer units are unsaturated and are susceptible to attack by oxygen. An antioxidant may be added to the coating composition to prevent the oxidation of the polymers in the polymeric binder resin. In some commercial polymers, an antioxidant is already provided with the polymer and additional antioxidant may not be needed. For example, commercial styrene-containing and diene-containing polymers, including the Kraton® Series D 1100 and G 1600 polymers, already have an amount of antioxidant added to the polymer to facilitate manufacturing, shipping, and storage. However, additional antioxidant may be added as desired or needed.

A variety of antioxidants are known and may be included in the coating composition. One suitable type of antioxidant includes a substituted phenolic compound. Commercial antioxidants of this type include Irganox® 1010 and 565 (Ciba-Geigy Co., Ardsley, N.Y.), Ethanox® 330 (Ethyl Corp., Baton Rouge, La.), and BHT (butylated hydroxytoluene, available from a variety of sources). Other types of antioxidants may also be used.

The coating composition may also include an ultraviolet (UV) absorber or blocker. This may be particularly useful in coating compositions that are exposed to sunlight or other sources of ultraviolet light. Examples of suitable UV absorbers or blockers include substituted benzotriazoles, hindered amines, benzophenones, and monobenzoates. Commercial UV absorbers or blockers include Tinuvin® P/300 Series and Tinuvin® 770 from Ciba-Geigy Co. (Ardsley, N.Y.), Cyasorb® UV 531 from American Cyanamid (Wayne, N.J.), and Eastman® RMB from Eastman Chemical Co. (Kingsport, Tenn.). Other types of UV absorbers or blockers may also be used.

Ozone blockers may also be used, particularly for coating substrates that will be exposed to air or to ozone-forming devices. Examples of ozone blockers include dibutyl thiourea, nickel dibutyl-dithiocarbomate (DuPont, Wilmington, Del.), Ozone Protector 80 (Reichhold Chemicals, Durham, N.C.) and the like.

The coating composition may also include a plasticizer. The plasticizer may be liquid or solid, and is present to increase the toughness and flexibility of the film coating. In many cases, a plasticizer is not needed as the combination of the polymers in the polymeric binder resin plasticize each other. However, when desired or needed an additional plasticizer may be added. Examples of useful plasticizers include butyl stearate, dibutyl maleate, dibutyl phthalate, dibutyl sebecate, diethyl malonate, dimethyl phthalate, dioctyl adipate, dioctyl phthalate, butyl benzyl phthalate, benzyl phthalate, octyl benzyl phthalate, ethyl cinnamate, methyl oleate, tricresyl phosphate, trimethyl phosphate, tributyl phosphate, trioctyl adipate phthalate esters and the like. Other secondary plasticizers are known such as chlorinated paraffins, polyethylene wax, polybutenes, isoprenes, Kratons, and flexible rubber compounds. Persons skilled in the art will be able to select the type and requisite combination of properties needed in the plasticizer to modify the binder resin. Preferred plasticizers include liquid phthalate plasticizers such as dioctyl phthalate, diethyl phthalate, butyl benzyl phthalate (SANTICIZER.TM. 160), benzyl phthalate, and octyl benzyl phthalate (SANTICIZER.TM. 261).

The amount of plasticizer used in the coating composition depends, at least in part, on the desired properties and the composition of the polymeric binder resin. Typically, the more plasticizer, the more elastic the film, however, if the amount of plasticizer is too great than the cohesiveness of the film resulting from the coating composition may decrease. A plasticizer may be particularly useful in combination with high styrene-content polymers.

Other components may be used in the coating composition. For example, small amounts of colloidal silica (e.g., Cab-O-Sil® M-5 or TS-610, Cabot Corp., Tuscola, Ill.), particularly in combination with mineral spirits, may cause the volume of the coating composition and the resulting film to increase. Examples of other optional components of the coating composition includes for example, perfumes, deodorants, foaming agents and tackifiers (e.g., Wingtack® series tackifiers from Goodyear Tire & Rubber Co., Akron, Ohio).

General Preparation Methods for Coating Compositions

The coating composition can be prepared by combining the organic solvent with between about 12 and 25 percent by weight of the total filler to be used in the composition. After mixing the solvent and a portion of the filler, the binder resin is added to the solvent/filler mixture. The resulting solvent/filler/binder resin material is mixed for about 30 minutes. The remaining filler is then added to mixture. The composition is then mixed for about 15 to 30 minutes.

A filler that includes sand and clay can be mixed prior to combining with the organic solvent/binder resin combination. Alternatively, the sand and clay can be added unmixed to the organic solvent/binder resin combination.

Waterproofing/Sealing Coating Composition

The liquid coating composition comprises a binder resin dissolved in an aromatic hydrocarbon solvent and a filler. In a preferred embodiment, the liquid coating composition is a combination of about 100 parts by weight of a binder resin comprising a polymer; about 100 to 235 parts by weight of an organic solvent; and about 290 to 1900 parts by weight of a filler, wherein the filler is of a size that at least 60 percent of the filler passes through a 325 mesh screen. More preferably, the liquid coating composition is a combination of about 100 parts by weight of a binder resin comprising a polymer; about 130 to 210 parts by weight of an organic solvent; and about 290 to 475 parts by weight of a filler, and the filler is of a size that at least 60 percent of the filler passes through a 325 mesh screen.

Optionally, one or more of the following can be included in the liquid composition: plasticizers; particulate solid pigments and opacifying agents; ultraviolet absorbers; ozone blockers; and antioxidants.

The liquid composition is relatively viscous, preferably having a Krebs Unit (KU) of about 117, and has a solids content of about 50 to 80 wt-%. More preferably, the solids content is about 55 to 60 wt-%. Most preferably, the solids content is about 55 wt-%.

Application of the Coating Composition

A coating composition can be applied by a variety of techniques, including, for example, rolling, brushing, spraying, squeeging, backrolling, pouring, troweling, or otherwise coating the surface of the substrate. A preferred application technique is spraying the coating on the substrate. Combinations of these techniques may also be used including spraying the coating composition on the structural unit and then rolling or brushing the sprayed coating composition to obtain a more uniform coating. The coating composition may be used on both interior and exterior surfaces of structures, as well as on other surfaces that need to be waterproofed.

The desired viscosity of the coating composition often depends on the method of application of the coating composition. Coating compositions that are formulated for application using a brush or roller can often be more viscous than those formulated for spraying. The desired viscosity may also depend on whether the surface to be coated is a vertical surface, where a less viscous coating composition may run, or a horizontal surface.

Spraying the coating composition on the substrate requires a flowable coating composition. Many physical properties affect flowability, such as, for example, viscosity, temperature, and the like. Usually, as the viscosity is lowered, the easier it is to spray the coating composition. Normally as the temperature of the material rises, the easier it is to spray the coating composition. Coating compositions applied year round in northern latitudes typically require special attention to maintain the flowability of the composition.

The thickness of the coating will often depend on the particular surface and material of the structural unit, as well as the projected exposure to moisture. Rougher surfaces and surfaces in areas with more moisture may require a thicker coating. In addition, thicker coatings may be used in situations where the coating may be subject to puncturing. For example, a coating on the exterior of a below-grade masonry unit, such as a foundation, should be thick enough to withstand bridging cracks that develop in the substrate and the backfilling process. Typical dry coating thickness range from about 5 to 100 mil (about 125 to 2500 □m), and preferably from about 15 to 35 mil (about 375 to 875 □m). Thicker and thinner coatings may also be used depending, in part, on the desired use of the structural unit.

Upon drying, the coating composition becomes a film. Typical drying times range from 4 to 24 hours. The drying time can be as short as 1 hour or even less. Longer drying times may be required depending on the thickness of the applied coating composition, the air temperature and humidity and the desired amount of solvent that should be removed.

Imperfections and damage in the resulting dried coating can be simply repaired by application of additional liquid composition over the area to be repaired. The solvent carrier remelts the underlying coating, and the repaired area dries to form a continuous film. This is in marked contrast to prior art systems and most paints which form layers with repeated applications.

The coating composition of the present-invention may be applied by itself or in conjunction with another waterproofing system. Additionally, the mechanical properties of the compositions make the coatings compatible with paints, including, but not limited to oil and latex based paints.

### EXAMPLES

The following examples further illustrate the invention. These examples are merely illustrative of the invention and do not limit the scope of the invention.

Between one quart and several gallons of different coating compositions (Table 1, labeled A-F) were prepared using the following materials and amounts:

TABLE 1
Materials and Amounts for the Coating Compositions

| | A | B | C | D | E | F |
|---|---|---|---|---|---|---|
| | (kg) | (kg) | (kg) | (kg) | (kg) | (kg) |
| Xylene | 0.75 | 0.74 | 2.26 | 2.26 | 1.39 | 1.39 |
| Recycled Styrene | 0.35 | 0.31 | 1.11 | — | 1.04 | — |
| HIPS Hunstman | — | — | — | 1.11 | — | 1.04 |
| Kraton 6120 | 0.07 | — | — | — | — | — |
| Kraton 1650 | — | 0.04 | — | — | — | — |
| Polybutene | — | — | 0.10 | 0.10 | — | — |
| Sand (65 Sieve) | 5.49 | 3.92 | — | — | — | — |
| Silica Flour | — | — | 5.20 | 5.20 | 3.08 | 3.08 |
| Wollastonite | 0.60 | — | — | — | — | — |
| Burgess Clay 2211 | 0.31 | 0.53 | — | — | 0.11 | 0.11 |
| Interfibe 230 | — | 0.04 | — | — | — | — |
| Titanium Dioxide Kerr- | — | — | 0.15 | 0.15 | 0.06 | 0.06 |
| McGee | | | | | | |
| Titanium Dioxide Ti-Pure ® | 0.15 | 0.03 | — | — | — | — |
| R-900 | | | | | | |

Generally, compositions A-F of Table were prepared as follows:

The coating compositions were prepared by combining the organic solvent with between about 12 and 25 percent by weight of the total filler to be used in the composition. After mixing the solvent and the portion of the filler, the binder resin was added to the solvent/portion of filler mixture. The resulting solvent/portion of filler/binder resin material was mixed for about 30 minutes. The remaining filler was then added to mixture. The composition was then mixed for about 15 to 30 minutes.

The compositions described above exhibited VOCs less than about 460, where VOC is defined by 40 C.F.R. § 59.406. Several compositions exhibited VOCs less than about 400. Some compositions exhibited VOCs at about 240.

Each coating was sprayed or brushed onto a substrate. Each coating composition was allowed to dry on a substrate, such as a masonry block. The resulting films were solid with a minimum of pinholing and had elastomeric qualities.

Many of the components used in the Examples were available from a variety of manufacturers and distributors. Wollastonite was available from NYCO Minerals, Inc. (Willsboro, N.Y.). Burgess Clay 2211 was available from Burgess Pigment Company (Sandersville, Ga.). Titianium Dioxide Kerr-McGee was available from Kerr-McGee Corporation (Oklahoma City, Okla.). Titanium Dioxide Ti-Pure® R-900 was available from E. I. du Pont de Nemours and Company (Wilmington, Del.). Interfibe 230 was available from ITC, Inc. (Hunt Valley, Md.). Polybutene was available from Morgan Materials (Buffalo, N.Y.) Xylene was available from a variety of manufacturers.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

Observations

Water vapor “permeance,” measured in “perms,” is the time rate of water vapor transmission through unit area of a flat material induced by a vapor pressure difference between two specific surfaces, under specified temperature and humidity conditions. The thickness of a material is not factored into a measure of “permeance.” Thus, the “perms,” or the rate of water vapor transfer, is decreased as the specimen thickness is increased.

Water vapor “permeability” is the time rate of water vapor transmission through unit area of flat material of unit thickness induced by unit vapor pressure difference between two specific surfaces, under specific temperature and humidity conditions. “Permeability” is the arithmetic produce of permeance and thickness.

Test Methods

The water vapor transmission test was conducted in accordance with ASTM E96-90, “Standard Test Methods for Water Vapor Transmission of Materials.” The test was conducted using both the dry-cup and wet-cup methods at conditions of 73 F. and 50% RH. Several 2.8″ diameter specimens from each sample group were tested. Each specimen was sealed, suing a rubber gasket or wax, in an aluminum water vapor transmission test cup containing dried anhydrous calcium chloride or deionized water. The test assemblies were placed in a Blue M model FR-446PF-2 calibrated environmental chamber, serial number F2-809, with conditions set at 73.degree.+2.degree. F. and 50+2% RH. Weight gain was monitored daily up until steady-state vapor transfer was achieved. The permeance for each specimen was calculated based on computer-generated graphs of the steady-state vapor transfer.

The KU measurements were made with a Brookfield KU-1+ Viscometer, which measures fluid viscosity in Krebs units. The KU measurements were made in accordance with ASTM D 562.

What is claimed is:

1. A waterproofing composition, comprising:
(a) about 125 to 235 parts by weight of an organic solvent;
(b) about 100 parts by weight of a binder resin, the binder resin comprising a styrene based polymer having a styrene content of 60 wt % or greater, the styrene based polymer selected from the group consisting of a styrene homopolymer, a styrene copolymer, and mixtures thereof; and
(c) about 290 to 1900 parts by weight of a filler, the filler having a size that allows at least 60 percent of the filler to pass through a 325 mesh screen.

2. The waterproofing composition of claim 1, wherein the styrene based polymer has a styrene content of greater than 80 wt %.

3. The composition of claim 1, wherein the filler is sand.

4. The composition of claim 3, wherein the sand is silica flour.

5. The composition of claim 1, wherein the filler includes a Blaine air permeability from about 2100 to 3200 square centimeters per gram of material.

6. The composition of claim 1, wherein the filler further comprises clay.

7. The composition of claim 1, wherein the organic solvent is xylene.

8. The composition of claim 1, wherein the composition has a VOC of less than 460.

9. A method of coating a surface of a substrate, the method comprising the step of:
applying a coating composition to the surface of the substrate, the coating composition comprising
(a) about 125 to 235 parts by weight of an organic solvent;
(b) about 100 parts by weight of a binder resin, the binder resin comprising a styrene based polymer having a styrene content of 60 wt % or greater, the styrene based polymer selected from the group consisting of a styrene homopolymer, a styrene copolymer, and mixtures thereof; and
(c) about 290 to 1900 parts by weight of a filler, the filler comprising sand.

11. The method of claim 9, wherein the styrene based polymer has a styrene content of greater than 80 wt %.

12. The method of claim 11, wherein the sand comprises silica flour.

13. The method of claim 9, further comprising the step of measuring a Blaine air permeability of the filler, wherein the filler includes Blaine air permeability from about 2100 to 3200 square centimeters per gram of material.

14. The method of claim 9, wherein the filler further comprises clay.

15. The method of claim 9, wherein the organic solvent is xylene.

16. The method of claim 9, wherein the composition has a VOC of less than 460.

17. A method for preparation of a composition, the method comprising the steps of:
(a) mixing an organic solvent with a portion of a filler, wherein the portion of the filler is about 12 to 25 percent of a total weight of the filler;
(b) mixing a binder resin into the organic solvent and portion of the filler;
(c) adding a remainder of the filler; and
(d) mixing the remainder of the filler.

18. The method of claim 17, wherein the styrene based polymer has a styrene content of greater than 80 wt %.

19. The method of claim 17, wherein the filler comprises sand.

20. The method of claim 19, wherein the sand comprises silica flour.

21. The method of claim 17, further comprising the step of measuring a Blaine air permeability of the filler, wherein the filler includes Blaine air permeability from about 2100 to 3200 square centimeters per gram of material.

22. The method of claim 17, wherein the filler further comprises clay.

23. The method of claim 17, wherein the organic solvent is xylene.

24. The method of claim 17, wherein the composition has a VOC of less than 460.
